(19) United States
(12) Patent Application Publication
(10) Pub. No.: US 2006/0230379 A1
(43) Pub. Date: Oct. 12, 2006

(54) System and method for generating a user interface based on metadata exposed by object classes

(75) Inventor: Fabio A. Pintos, Kirkland, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/099,810

(22) Filed: Apr. 6, 2005

(51) Int. Cl. G06F 9/44

(52) U.S. Cl. 717/109

(57) ABSTRACT

Building controls and bindings for the assembled classes. The metadata and associated properties of the classes is read and comparing with a pre-defined set of type mappings to select a corresponding control factory from a plurality of factories. The selected factory is executed to define a control and a corresponding binding added to a form to generate the UI.

### TECHNICAL FIELD

Embodiments of the present invention relate to the field of generating a user interface. In particular, embodiments of this invention relate to a system and method for generating a UI from an assembly of object classes, each having metadata and associated properties.

### BACKGROUND OF THE INVENTION

When building large enterprise applications a lot of time and human effort is spent developing the user interface of the system due to the large number of object types such system may provide. Each object type has metadata defining unique properties, so it is usually difficult to share property pages or any other user interface between types. Granted, there is a set of common properties and these can live in a shared interface but, outside that, each type is pretty much on its own. This causes the development time to grow at least linearly with the number of types and properties that are to be exposed in a manually coded and maintained user interface.

There is a need for a system and method which automatically generate a user interface at runtime, based on the metadata exposed by object classes, eliminating the need of coding and maintaining the source code of such user interface. There is also a need for a system and method which is designed to work with multiple types of user interfaces—referenced herein as devices—such as rich client applications, web applications and command line applications.

### SUMMARY OF THE INVENTION

This invention eliminates the need to have such an UI manually coded and included in binary form, reducing the amount of human effort required to produce the UI for a given business object class.

The invention reduces the development time of user interface applications by providing a standard, automatically generated UI and is targeted particularly to data entry form.

The automatic UI generation system and method (AutoGen) of the invention generates the UI for most of the business objects and tasks in an application and provides the necessary infrastructure to use reflection to initialize properties in the generated controls and to extract values of a control and set it back into instances of the reflected type. It supports both single and multi-selection scenarios, where the same UI is used to change values in one or multiple target instances.

In one embodiment, the invention is a method for providing a unified programming interface to generate a UI for the different input/output devices, such as graphical UI applications, command line applications, telephone applications. The method comprises building assembled object classes of the application, each object class having metadata and associated properties; building controls and bindings for the assembled object classes; and adding the defined control and binding to a form to generate the UI. The controls are built by reading the metadata and associated properties of the object classes, comparing the associated properties with a predefined set of type mappings to select a corresponding control factory from a plurality of factories, and executing the selected factory to define a control and a corresponding binding.

In another embodiment, in a computer system having an application using a user interface (UI) for an input/output device for the application, the invention is a method of generating the UI from an assembly of object classes of the application, each object class having metadata and associated properties. The method comprises:
building controls for assembled object classes by reading the metadata and associated properties of the object classes, comparing the associated properties with a pre-defined set of type mappings to select a corresponding control factory from a plurality of factories, and
executing the selected factory wherein the executed factory defines a control and a corresponding binding added to a form to create the UI.

In another embodiment, the invention is a computer readable medium having instructions for providing a unified programming interface to generate a UI for the different input/output devices, such as graphical UI applications, command line applications, telephone applications. The instructions comprise:
Identifying a type of object class to illustrate as a target IU,
Obtaining an array of object classes which represent the metadata of the properties to be illustrated;
Creating a device corresponding to the target UI;
Using the device to create the corresponding controls and bindings;
Using the created bindings to populate the UI; and iterating thru the bindings and using them to set values from the controls into the object class.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of an exemplary embodiment of an auto-generation (AutoGen) system and method according to the invention.

FIG. 2 is a UI data-entry form for an email message that can be generated automatically with AutoGen.

FIG. 3A illustrates a task namespace in a main menu, and opening that menu allows the user to select a new task shown in FIG. 3B. Clicking on the “create/sample” link of FIG. 3B executes the command that shows the generic task wizard, which then uses AutoGen to populate the UI illustrated in FIG. 3C.

FIG. 4 illustrates the UI for a name attribute resulting from FIG. 3C.

FIG. 5 illustrates the resulting UI for an age attribute added to the name attribute UI of FIG. 4.

FIG. 6A shows the mandatory name property; FIG. 6B shows the optional properties disabled; and FIG. 6C shows the optional father property of FIG. 6B enabled.

FIG. 7 illustrates adding attributes as localized descriptions to the sample results.

FIG. 8 is a block diagram illustrating one example of a suitable computing system environment in which the invention may be implemented.

Corresponding reference characters indicate corresponding parts throughout the drawings.

### DETAILED DESCRIPTION OF THE INVENTION

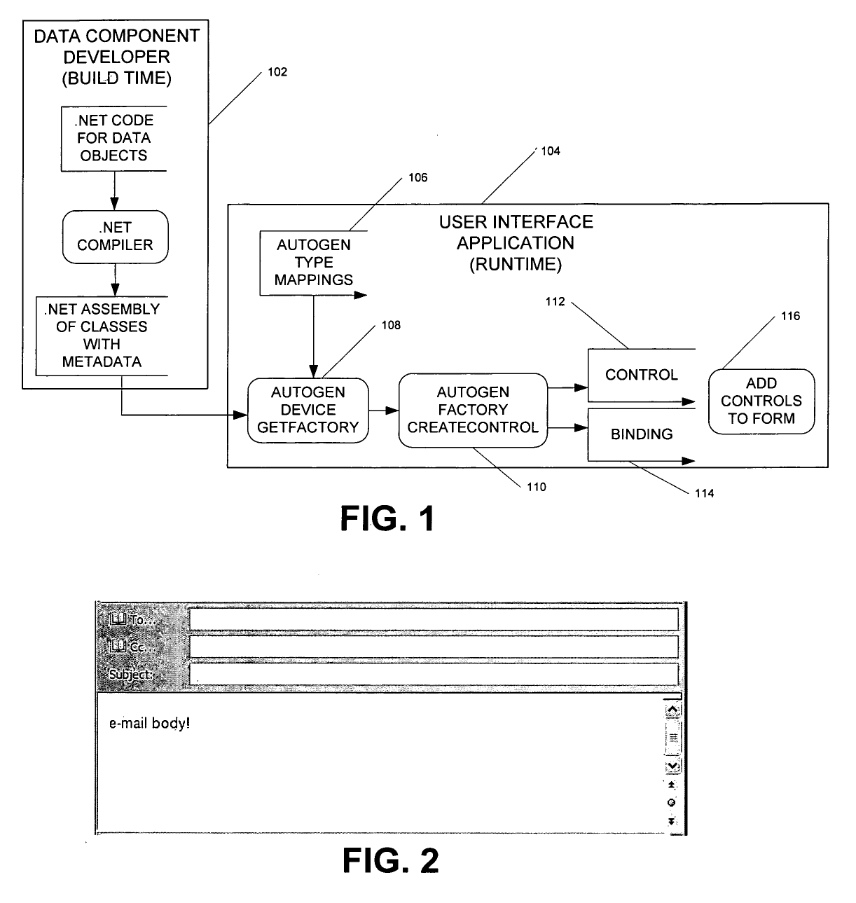

Referring to FIG. 1, a data component developer, such as a human programmer (or a build system) builds code for data objects for which a UI is to be automatically generated. For example, using a .net compiler, the developer writes code for .net data objects. The code is compiled into an assembly, which contains the object classes of the application, each class having metadata and properties associated with it. This part is illustrated in FIG. 1 as a build time block 102. An application including the assembled code is provided to users, who run the application, which is illustrated in FIG. 1 as a runtime block 104. At runtime 104, the information generated during build time 102 is used to dynamically generate the UI for the data objects found in the assembly.

At runtime 104, the UI application requests the automatic generation system (AutoGen) to build the controls for a given data object. AutoGen reads the metadata of the data objects and compares the types of the properties with a pre-defined set of type mappings 106 to find the correct control factory at 108. The factory at 110 creates a control 112 and a corresponding binding 114 which are added to a form at 116. The control properties are pre-populated with values extracted from the data object and are ready for interaction with the end user of the application. The process repeats once for each property in the data object and once all properties are processed the form is displayed to the user.

The following is an abstract of one of the samples in the AutoGen code for .net applications:

```
// Suppose you have a data object that looks like this in C# code:
class Mailbox
{
  - public string Name { get {...} set {...} }
  - public string Address { get {...} set {...} }
}
```

Without AutoGen, a user interface (UI) developer needs to write a dialog (e.g., a WinForms dialog), populate it with labels and textboxes and setup data-bindings manually. Such manually coded dialog can easily have more than 20 or 30 lines of code and may contain several types of bugs, if the developer is not careful, such as control alignment, incorrect tab order, duplicated mnemonics and resizing problems.

With AutoGen, creating the dialog is a lot simpler. The developer simply allocates an AutoGen device and asks the device to create the controls, based on a particular data object. The code would look similar to this:

```
// Allocate a Form where we will add the control created by the device
Form form = new OkCancelForm( );
// Allocate the data object
Mailbox mailbox = new Mailbox( );
// The next lines replace the 20+ lines of normal WinForms
// code necessary to manually code a similar dialog:
// Allocate the WinForms device and ask it to create the controls
// for the mailbox object and to layout them in the given form:
WinFormsDevice device = new WinFormsDevice( );
device.CreateControls(form, mailbox);
// Show the form and if the user presses the OK button, do something
with the mailbox:
if (DialogResult.OK == form.ShowDialog( ))
{
  // mailbox.Name and mailbox.Address will be set to the values
specified by
  // the user in the dialog
}
```

The above sample is simplistic since it deals with strings, but other data types can generate more complex controls. See FIGS. 2-10 below for a larger data source sample and screen shots for a more involved example.

The following is a sample of a cmdline scenario. The application code would look similar to the WinForms sample noted above, but with a command line scenario in mind (instead of a form, the System Console class is used to interact with the user):

// Allocate the data object
Mailbox mailbox = new Mailbox( );
// Allocate the command line device and ask it to create the controls
// for the mailbox object and to use the Console to interact with the
// end user.
CommandLineDevice device = new CommandLineDevice( );
device.CreateControls(Console, mailbox);
// mailbox.Name and mailbox.Address will be set to the values specified
by
//the user in the command line

The output of the application would be something like this: the user starts by typing “create-mailbox” to invoke a command in the command line. The application inspects the metadata using AutoGen's CreateControls and that causes it to interact with the user by asking for the Name and Address properties:

$>create-mailbox
Name: Fabio Pintos
Address: fpintos@domain.com
The operation was completed successfully.

Again, the above sample is simplistic and one may think that a simple call to Console WriteLine and ReadLine would be sufficient. But when the types involved are more complex and include validation, masked input and any other variety of complex operations, having a unified interface to deal with all cases can simplify the development process.

The following describes one embodiment of a design of AutoGen, including a set of components and concepts used to reduce the complexity and cost of building a user interface by automatically generating views at runtime based on data models.

In this embodiment of AutoGen components are built that will automatically generate a user interface for any number of types in the system. Using AutoGen, a developer will not need to code a user interface directly. AutoGen can be reused in several different scenarios, reducing the development and test times of each individual case.

One aspect of AutoGen is that each type can be associated with a smart control that knows how to display and create instances of the associated type. Primitive types can have simple representations: a string can be represented with a TextBox, a boolean with a CheckBox and so on. Other types may require a specialized UI, for example, a DateTime property is likely to require a calendar control while a DistinguishedName could be represented in the UI with an object picker. If a type is composed of several properties, smart controls can be gathered together by recursively looking at all the properties and their associated types.

With these assumptions in mind, it is possible to generate user interface to create and view instances of any type, by enumerating the properties that belong to the type and stacking the corresponding controls on a window so that the user can interact with them. The user can then interact with each control, looking at existing values and changing them. At any point in time the values on these controls can be set on an instance corresponding to the type used to generate the interface.

Blindly stacking controls is of little use because the user cannot identify them, so around each control one or more services should be provided: having descriptive information, restricting the input to valid values, doing layout of the controls in a meaningful and pleasant order while providing space for localization, and providing other details that make up a useful user interface.

A user interface (UI) is not limited to a graphical, windowed application. Potentially any kind of input/output device can be used to auto-generate a UI: window, command line, web browser, telephone. As long as a mapping can be generated between a type and the appropriate representation of that type in the target device, a user interface can be generated automatically. For example, in a command line interface, looking at a value means writing the string representation of that value to the console and changing the value means asking the user to type the string representation of the new value in the console and then converting the string to the actual value. In a phone device, looking at a value means synthesizing the string representation of a value to the phone and changing a value means asking the user to say the new value or push buttons on the phone and then converting the speech or tones into a meaningful value. T

AutoGen instantiates, configures and data binds controls. How the resulting controls are rendered in the resulting UI will depend on the application using AutoGen. One question that usually comes to mind is ‘does the UI of an application has to be completely created with AutoGen?’ and the answer is no. AutoGen does not force or decide anything for the application: AutoGen is a tool and as such it is used by an application. The application is ultimately in control of what, when, where and how the UI is generated, AutoGen merely makes it easier for a developer to create UI without writing UI specific code. In particular, AutoGen will not decide if a given command or control should show up on the UI or not. Thus, AutoGen will not “show” controls on the UI. Again, this responsibility is of the application. AutoGen will create the controls, but showing them on a window is a decision made by the application using AutoGen. Also, AutoGen will not “run” tasks—it will just generate UI for them, like it would for any other type in the system. Running tasks or executing any other operation on the generated UI is outside the realm of AutoGen and belongs to the application itself. Also, AutoGen will not instantiate anything other than UI controls and their associated components.

Strong Types and their Relationship with Autogen

It is often the case that types are developed with primitive types, like strings and integers. One may consider the “To” property of an “EMailMessage” as a type string. However, in the context of this invention, even though the property can be represented as a string, such as email@address.com, it has more to it. Not any string can be used as an e-mail address—it has to be a valid e-mail address or maybe a set of e-mail addresses, so the passed string needs to be validated before being used. The more places a string is used to represent a recipient, the more places it needs to be validated; therefore, the more places there can be bugs. It is also not clear to whoever is using the class that the property has such a restriction, unless it is documented somewhere else.

This is how a class would look like following this simplistic principle:

```
class EMailMessage
{
  string To { set { if (!IsValidAddress(value)) throw;
  this.to = value; } }
  string Cc { set { if (!IsValidAddress(value)) throw;
  this.cc = value; } }
  ...
}
```

By refactoring the above class, a strong type is created to eliminate the deficiencies of the above class:

```
class Recipient
{
  Recipient(string value) { if (!IsValidAddress(value) throw; ... }
  ...
}
class EMailMessage
{
  Recipient To { set { this.to = value; } }
  Recipient Cc { set { this.cc = value; } }
  ...
}
```

This new model has the same functionality as the one before, with the added benefit that the EMailMessage now has a stronger interface and there's only one place where data validation will happen; therefore, less chances for bugs to show up.

Now, consider the user interface and how the use of strong types assist in creating a UI. Smart controls are controls that have more knowledge about the data they are supposed to generate than plain controls. For example, a TextBox generates strings, allowing the user to type all sorts of characters in it—that's a plain control. A RecipientTextBox will filter out invalid characters that cannot be part of a recipient's address and perhaps it can have a button that allows you to browse an address book—that's an example of a smart control. Another smart control example would be a FileNameTextBox, which would not only filter invalid characters but it would also auto-complete file names as the user types them.

Strong types and smart controls can exist independently from each other but when both concepts are joined together, then AutoGen is particularly effective in creating a UI. When each strong type is associated with its corresponding smart control, a user interface can be generated automatically for more complex types.

Consider the classes in the above examples: trying to figure out which controls to use for the first one, without having knowledge of the internal semantics of the class, would lead us to conclude that a plain TextBox for To and Cc would be acceptable; after all, the properties are just strings.

On the other hand, because the second class has properties with strong types, a plain TextBox is not enough, and the RecipientTextBox would be used. Because this decision can be made based on syntax, not semantics, it can easily be automated.

It is important to notice that smart controls exist for a rich user experience and there's no AutoGen cost in building a smart control. The cost of adding them to AutoGen is compared with the cost of manually coding the instantiation, configuration and all the data binding once.

Let's look at other examples: if an integer is not any integer (from int.MinValue to int.MaxValue), it can be defined as a strong type, Ex: FileSize, DatabaseFileGrowth.

If a string is not any string (all characters, null or empty), it can be defined as a strong type, Ex: DatabaseFileName, DistinguishedName, CommonName, TeleText, SmtpAddress.

The following is an example of what can be accomplished with AutoGen. Following this example is a sample using Tasks and AutoGen.

Suppose you have a type that looks like this:

| | | |
|---|---|---|
| class EMailMessage | | |
| { | | |
| Recipient | To | { get {...} ; set {...} } |
| Recipient | Cc | { get {...} ; set {...} } |
| string | Subject | { get {...} ; set {...} } |
| EMailBody | Body | { get {...} ; set {...} } |
| } | | |

Now suppose the appropriate controls to represent a Recipient type and the EMailBody type and strings is some type of text box. If AutoGen creates the UI for EMailMessage, a screen similar to the one illustrated in FIG. 2 will be the result (note the one-to-one mapping between the properties of the type and the controls). FIG. 2 is a UI data-entry form for an email message that can be generated automatically with AutoGen, again, assuming that the smart controls were implemented. This form is located inside a window with menus & toolbars to end up with a screen that looks like a message. AutoGen could also be used to initialize and set the data in the controls from and to an instance of the EMailMessage. After that, the message would be ready for processing by other parts of the application.

AutoGen is one piece of the process and system used to build a user interface application. Other actions may be used. For example, in Exchange, Commands and Tasks are used to make a complete application. To understand how these pieces fit together, consider the following common scenario:
The application starts and creates a set of commands, some of them corresponding to the tasks available in the system. These commands end up arranged on the UI as menus, links, buttons and toolbars.
Suppose the user clicks on the “Create Mailbox” link. That causes the create mailbox command to run, which will be coded to show a generic task wizard for the create/mailbox task.
The generic wizard uses AutoGen to generate the controls for the task and it creates the necessary pages that the user will follow.
The user fills up the wizard and eventually clicks the Finish button.
The wizard uses AutoGen to extract the values from the generated controls and set them on an instance of the create/mailbox task. If everything is fine, the task is then executed.
   AutoGen Components

AutoGen maps types to user interface controls that show and gather data of the respective type. Reflection is used to inspect types and to get and set values in instances. Metadata is used to control several aspects of the generated controls. Note that, by reflection, we mean the mechanism offered in a type system by which a program can obtain information about the types and properties of programs—this is also known as runtime type information.

Definitions

AutoGen defines some concepts that are used to make it all work: devices, device-depended controls, factories and bindings. Devices contain mappings between types and factories. When generating UI for a given property, the factory corresponding to the property type is used to create a device-dependent control and a binding that links them all together is returned. When the application needs to extract values from the generated controls, the binding provides all the necessary services. AutoGen works by mapping types to user interface controls that show and gather data of the respective type. Metadata is used to control several aspects of the generated controls.

Type Mapping

The type mapping data structure is essentially a dictionary where keys are Type objects and the value of each key is an arbitrary object. What makes the type mapping different from usual dictionaries is its lookup function. When looking up the value of a type T, if there's no explicit entry for T, then the base class of T is considered. This process repeats until an entry for any of the base classes is found or it runs out of base classes. In other words, when comparing the associated properties of an object class to the predefined set of type mappings, a control factory corresponding to a base type mapping is selected when the associated properties do not correspond to any of the predefined set of type mappings. The order in which the mappings are added to the dictionary is not relevant.

Devices

An AutoGen device represents a “surface” that provides input and output services to the user. A surface is a control (e.g., a WinForms control), a command line console or even a telephone line. The application uses a device to create device dependent controls for all properties it wants to expose.

The device uses a type mapping to find factories for a given type. For example, a device will map the string type to a TextBox factory. Application specific types can also be added to the device to support complex types. The factory can then be invoked to create the control and its state is initialized to match the value of the corresponding property from a particular object instance. When the user is done using the control, the factory is invoked again to extract the value out of the control and the value is set on the appropriate property on the same, or even a different, instance.

The following code illustrates the skeleton implementation of a device, from which we derive classes that handle each particular UI target, such as WinForms, command line or other forms of interaction with the user:

```
/// <summary>
/// Base AutoGen Device to provide I/O with the use of device-dependent
controls.
/// </summary>
public abstract class Device
{
  /// <summary>
  /// Create controls and bindings for the given properties.
  /// </summary>
  /// <param name=“instances”>Instances from where to get default
values.</param>
  /// <param name=“properties”>Metadata of the properties to bind
to.</param>
  /// <returns>The array of bindings created.</returns>
  public AutoGenBinding[ ] CreateBindings(System.Collections.IList
instances, PropertyDescriptor[ ] properties)
  {
    ArrayList bindings = new ArrayList(properties.Length);
    for (int i=0; i<properties.Length; i++)
    {
      AutoGenBinding binding =
this.CreateBinding(instances, properties[i]);
      if (null != binding)
        bindings.Add(binding);
    }
    return (AutoGenBinding[ ])
bindings.ToArray(typeof(AutoGenBinding));
  }
  /// <summary>
  /// Creates a new control and the corresponding binding for the
given property.
  /// </summary>
  /// <param name=“instances”>Instance from where to get default
values.</param>
  /// <param name=“property”>Property to bind.</param>
  /// <returns></returns>
  public AutoGenBinding CreateBinding(System.Collections.IList
instances, PropertyDescriptor property)
  {
    IFactory factory = this.GetFactory(property.PropertyType);
  object AutoGenControl = factory.CreateControl(this,
instances, property);
  return new AutoGenBinding(AutoGenControl, propertyInfo,
factory);
  }
  /// <summary>
  /// Gets the factory associated with the given property type.
  /// </summary>
  /// <param name=“type”>
  /// Type of the property to look for.
  /// </param>
  /// <returns>A factory capable of creating controls for the given
type.</returns>
  /// <remarks>
  /// The return value of this function cannot be null regardless of the
type since
  /// all devices must support a factory for typeof(object).
  /// </remarks>
  protected virtual IFactory GetFactory(Type type)
{
return typeMapping[type];
}
// A type mapping where we store which factories handle
// which property types.
TypeMapping<IFactory> typeMapping;
}
```

Device Dependent Controls

Each input/output device used by AutoGen provides a series of controls specialized in providing user interface for the supported types. For example, some of the controls in the WinForms device are the ones that display strings as textboxes and booleans as checkboxes. Because each device has unique input/output capabilities, the richness of each control really depends on the richness of the device itself—for example, a boolean type may be represented as a checkbox in WinForms while in the command line it will wait for the user to press Y or N. While these controls provide user interface services, they do not get or set properties in object instances by themselves. This work is done by the control factory.

One important aspect of one embodiment of the controls is that they work independent of each other. It is often the case where there is a need for a user interface that shows a checkbox that when checked, enables or disables another control. To address this, the UI and its underlying type could be factored, perhaps even with different types, so that the dependency will not occur. If factoring is not possible, then custom code can be written to bind the generated controls together. It's important to keep in mind that the application is always in control of the generated UI and it can be customized in whatever way it is necessary.

Factories

A factory is an object that is responsible for creating and initializing the appropriate control for a given property type and also to extract the value of the control so that it can be set back into an object. This model allows AutoGen to easily support multi-selection scenarios, where the value of a control must be set into several objects and it allows controls to be reused in different scenarios. Usually there is a factory for each control the device supports, but nothing prevents a factory from dealing with multiple controls and choosing the one that is best for any specific situation.

AutoGen factories implement the following interface:

```
/// <summary>
/// Interface implemented by classes that generate controls for AutoGen.
/// </summary>
public interface IFactory
{
  /// <summary>
  /// Creates the control that provides UI for the given propertyInfo.
  /// </summary>
  /// <param name=“device”>Device where control is being
created.</param>
  /// <param name=“instances”>Instances that provide the default
value of the control.</param>
  /// <param name=“property”>Property the new control should
represent.</param>
  /// <returns>Control that represents the property in the device. Null
if the device does not support the property.</returns>
  object CreateControl(Device device, IList instances,
PropertyDescriptor property);
  /// <summary>
  /// Retrieves the value of the given control and sets it on the given
instance using the given property descriptor.
  /// </summary>
  /// <param name=“instance”>Instance where the value should be
set.</param>
  /// <param name=“propertyInfo”></param>
  /// <param name=“control”>Control from where to extract the
value.</param>
  void SetValue(object instance, PropertyDescriptor property, object
control);
}
```

Bindings

Controls are created to be reusable and have little or no knowledge of how they are really being used. The device and the factory can make decisions based on the type of property and other attributes so it is important to extract the value of a control using the same factory that created it. AutoGen creates binding objects that link together the control, the factory and the property being represented. Applications iterate over all the bindings created to get properties out of the controls and to set them in the appropriate instance.

AutoGen bindings are implemented with a class that follows this pattern:

```
/// <summary>
/// AutoGen Binding between a property, the corresponding control and the
factory that created it.
/// </summary>
public sealed class AutoGenBinding
{
  /// <summary>
  /// Creates a new instance of this class.
  /// </summary>
  /// <param name=“control”>Control created by the factory for the
property.</param>
  /// <param name=“property”>Property used to create the
control.</param>
  /// <param name=“factory”>Factory used to create the
control.</param>
  public AutoGenBinding(object control, PropertyDescriptor property,
IFactory factory);
  /// <summary>
  /// Sets the value of the control in the corresponding property of the
given instance.
  /// </summary>
  /// <param name=“instance”>Instance to update with the value of
the control.</param>
  public void SetValue(object instance);
  {
    this.Factory.SetValue(instance, this.Property, this.Control);
  }
...
}
```

### Usage of AutoGen in User Interface Applications

To generate an UI with AutoGen, an application would perform the following steps:
Starting with the type of business object to show, use TypeDescriptor.GetProperties( ) or any other mechanism to get an array of System.ComponentModel.PropertyDescriptor objects, which represent the metadata of the properties to show.
Create the AutoGen Device corresponding to the target UI. For example, a WinFormsDevice would be created for WinForms dialogs.
Use the Device's CreateBindings( ) method to let AutoGen create the corresponding controls and bindings.
Use the returned bindings to populate the UI and interact with the user in a manner specific to the target UI. For example, WinForms may allow the user to interact with all controls at once in a dialog while a command line application is likely to prompt for the value of each control in sequence.
Once the dialog with the user is finished, iterate thru the bindings and use them to set values from the controls back into business logic objects.

Devices are free to implement helper functions that encapsulate these steps in one call, further minimizing the need for the UI developer to code these steps for every dialog.

Controls created by AutoGen can be freely mixed with a manually created controls because the application always has the final decision of how the controls are presented to the end user.

An Example: AutoGen and the Exchange Task UI

During the development of Microsoft Exchange a task based UI was implemented using AutoGen. The application was designed to show all ‘tasks’ in the Exchange system and to allow the user to run any of these tasks, filling the parameters. In addition, the UI application was designed to not have any task-dialogs manually coded. The following is an extract from the design documents of the Exchange Task UI:

“The following example illustrates how a component developer would extend the Exchange Task UI with the use of tasks and use AutoGen to handle the user interface.

Exchange Tasks will be the primary means of extending the application. AutoGen will take care of generating a UI for most tasks, so component developers can focus on the system's business logic, a feature without a UI, knowing the Task UI will handle the interaction with the user.

Creating the Task

When an extension assembly is loaded, the application, not AutoGen, uses reflection to look for all public classes derived from Microsoft.Exchange.Manangement.Tasks.Task that also have the TaskDescriptionAttribute. These are considered as end-user visible-tasks. So, the initial step in creating an extension is creating the corresponding task:

```
using System;
using Microsoft.Exchange.Management.Common;
using Microsoft.Exchange.Management.Tasks;
namespace SampleExtension
{
  [TaskDescription(Verb=“create”, Noun=“sample”)]
  public class CreateSampleTask : Task
  {
    public CreateSampleTask( )
    {
    }
    protected override void InternalExecute( )
    {
    }
    protected override void InternalRollback( )
    {
    }
  }
}
```

To load this task into the application, the configuration file needs to be updated with the name of the assembly containing the task. The <extensions> section contains an <extension> element for each assembly that is to be loaded. Assuming the task above was compiled into the SampleExtension.dil, adding and entry to our esm.exe.config file will make it look like this:

```
<configuration>
<configSections>
  <section name=“extensions”
type=“Microsoft.Exchange.Management.SystemManager.Extension,ESM”
/>
</configSections>
<extensions>
  <extension>Microsoft.Exchange.Management</extension>
  <extension>SampleExtension</extension>
</extensions>
</configuration>
```

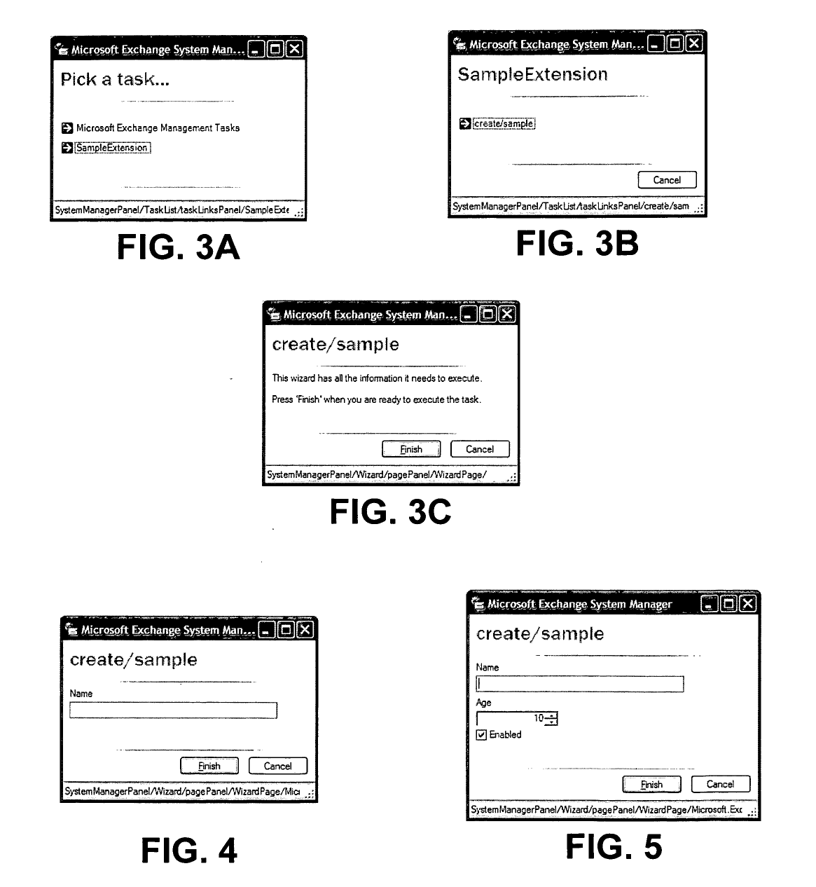

At this point the application can be loaded and a new link will be available in the user interface, as illustrated in FIGS. 3A and 3B.

As you can see from FIGS. 3A and 3B, the task namespace shows up in the main menu of FIG. 3A, and opening that menu allows the user to select the new task shown in FIG. 3B. Again, this is all application specific and so far AutoGen was not involved.

Clicking on the “create/sample” link of FIG. 3B executes the command that shows the generic task wizard, which then uses AutoGen to populate the UI illustrated in FIG. 3C.

Since the task has no public properties, the task wizard does not present the user with any further options. Unlike this sample, most tasks require user input and that is accomplished in the Task model with the use of properties.

Mandatory Properties

When generating UI for tasks, the task wizard will inspect the task type and will provide user interface for all public, instance properties tagged with the TaskPropertyDescriptionAttribute:

```
  [TaskDescription(Verb=“create”, Noun=“sample”)]
public class CreateSampleTask : Task
  {
    [TaskPropertyDescription(ParameterTypes.Mandatory)]
    public string Name
    {
      get { return (string) this.Fields[“name”]; }
      set { this.Fields[“name”] = value; }
    }
    ...
  }
```

FIG. 4 illustrates the resulting UI for a name attribute.

Different property types generate different user interfaces, according to their type. For example, boolean properties are represented as checkboxes and numbers are represented with spin controls. Pre-set values are also exposed in the user interface accordingly:

```
[TaskDescription(Verb=“create”, Noun=“sample”)]
public class CreateSampleTask : Task
{
  public CreateSampleTask( )
  {
    this.Age = 10;
    this.Enabled = true;
    }
  [TaskPropertyDescription(ParameterTypes.Mandatory)]
  public string Name
  {
    get { return (string) this.Fields[“name”]; }
    set { this.Fields[“name”] = value; }
  }
  [TaskPropertyDescription(ParameterTypes.Mandatory)]
  public int Age
  {
    get { return (int) this.Fields[“age”]; }
    set { this.Fields[“age”] = value; }
  }
  [TaskPropertyDescription(ParameterTypes.Mandatory)]
  public bool Enabled
  {
    get { return (bool) this.Fields[“enabled”]; }
    set { this.Fields[“enabled”] = value; }
  }
  ...
}
```

FIG. 5 illustrates the resulting UI for an age attribute added to the name attribute UI of FIG. 4.

The order in which the controls are laid up in the window follows the order in which the properties are given to AutoGen. By default, the generic task wizard uses reflection to get the list of properties, so the order will follow how the type was originally coded. Applications can override this behavior by sorting and filtering the properties before handing them to AutoGen.

Optional Properties

The wizard also uses AutoGen to handle optional properties. These usually show up using the “normal” user interface with a checkbox by its side. Checkboxes are a special case, since they support tri-state—that makes them look better. Other controls may also have a different optional state—UI design will dictate how each and every one will appear.

The generic task wizard will keep all properties in one page but if the task contains a mix of mandatory and optional pages and there's at least 2 of each, then the wizard break the UI in two steps.

This sample shows how optional properties show up in the wizard:

```
[TaskDescription(Verb=“create”, Noun=“sample”)]
public class CreateSampleTask : Task
{
  public CreateSampleTask( )
  {
    this.Age = 10;
    this.Enabled = true;
    this.Mother = “Default mother”;
  }
  [TaskPropertyDescription(ParameterTypes.Mandatory)]
  public string Name
  {
    get { return (string) this.Fields[“name”]; }
    set { this.Fields[“name”] = value; }
  }
  [TaskPropertyDescription(ParameterTypes.Mandatory)]
  public int Age
  {
    get { return (int) this.Fields[“age”]; }
    set { this.Fields[“age”] = value; }
  }
  [TaskPropertyDescription(ParameterTypes.Mandatory)]
  public bool Enabled
  {
    get { return (bool) this.Fields[“enabled”]; }
    set { this.Fields[“enabled”] = value; }
  }
  [TaskPropertyDescription(ParameterTypes.Optional)]
  public string Father
  {
    get { return (string) this.Fields[“father”]; }
    set { this.Fields[“father”] = value; }
  }
  [TaskPropertyDescription(ParameterTypes.Optional)]
  public string Mother
  {
    get { return (string) this.Fields[“mother”]; }
    set { this.Fields[“mother”] = value; }
  }
  [TaskPropertyDescription(ParameterTypes.Optional)]
  public string Spouse
  {
    get { return (string) this.Fields[“spouse”]; }
    set { this.Fields[“spouse”] = value; }
  }
  ...
}
```

The first page in the wizard will always contain the mandatory properties, if there are any. Optional properties will also be on the first page if there are just a couple of them and also a few mandatory ones. Since this sample has lots of properties, the wizard automatically breaks them in two pages.

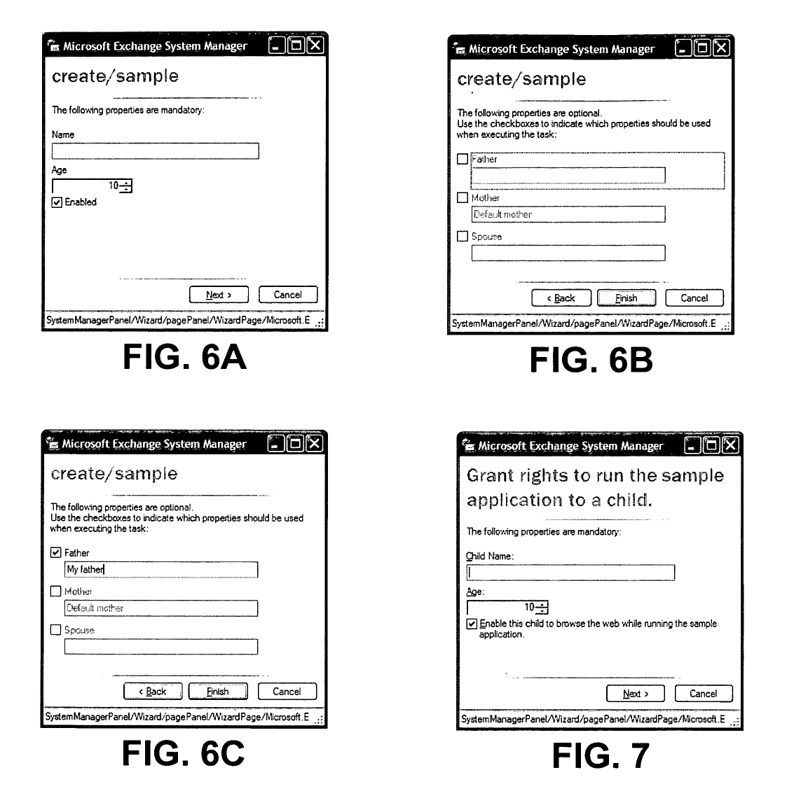

Optional properties start disabled and will not be set in the task object unless the user checks the corresponding checkbox. FIG. 6A shows the mandatory name property; FIG. 6B shows the optional properties disabled; and FIG. 6C shows the optional father property of FIG. 6B enabled.

Localized Description

While the above sample generates a functional user interface, it lacks localized descriptions for both the task and its properties. AutoGen will look for the DescriptionAttribute and will use it when available. Developers can use the LocalizedStringGen tool during build to generate resources and classes to deal with localized strings—this tool will create the LocDescription attribute which provides localized strings with strong typing, which helps reduce the possibility of bugs. As illustrated in FIG. 7, adding such attributes as localized descriptions to the sample results in a much better user interface:

```
[TaskPropertyDescription(ParameterTypes.Mandatory)]
[LocDescription(Strings.ChildName)]
public string Name
{
  get { return (string) this.Fields[“name”]; }
  set { this.Fields[“name”] = value; }
}
```

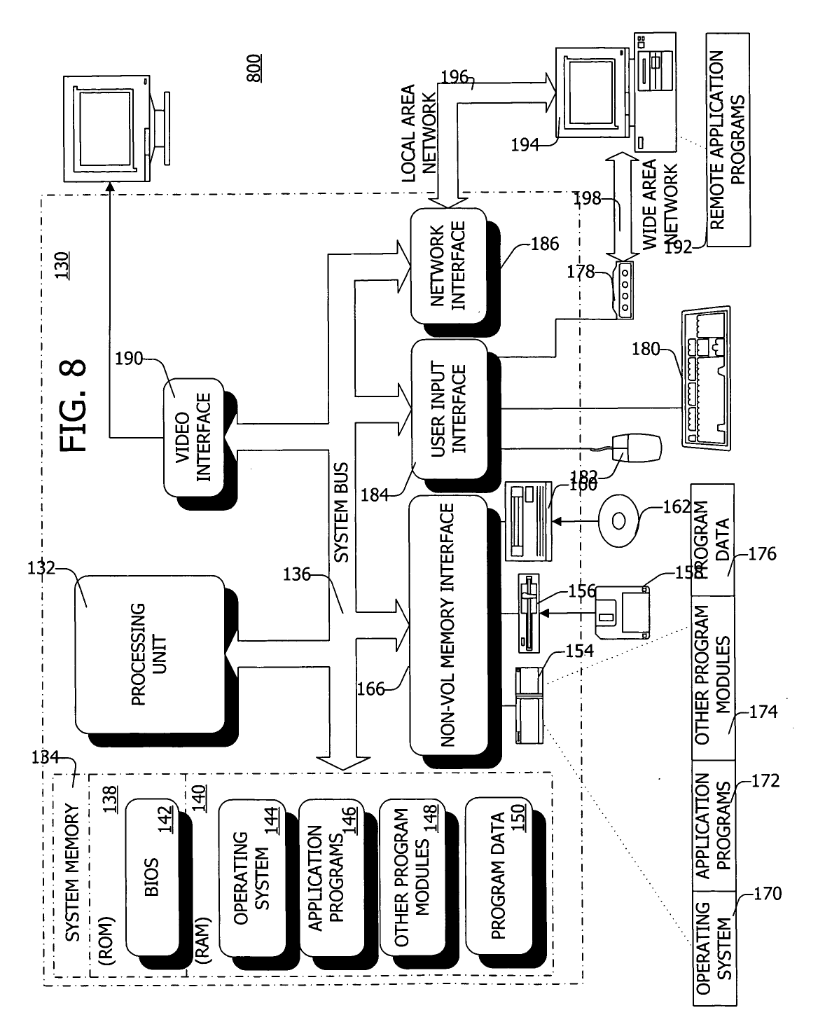

FIG. 8 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 8 illustrates operating system 144, application programs 146, other program modules 148, and program data 150.

The computer 130 may also include other removable/non-removable, volatile/nonvolatile computer storage media. For example, FIG. 8 illustrates a hard disk drive 154 that reads from or writes to non-removable, nonvolatile magnetic media. FIG. 8 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 8, provide storage of computer readable instructions, data structures, program modules and other data for the computer 130. In FIG. 8, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 8 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 8 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method for providing a unified programming interface to generate a UI for the different input/output devices, such as graphical UI applications, command line applications, telephone applications, comprising:
building assembled object classes of the application, each object class having metadata and associated properties; and
building controls and bindings for the assembled object classes by:
reading the metadata and associated properties of the object classes,
comparing the associated properties with a predefined set of type mappings to select a corresponding control factory from a plurality of factories, and
executing the selected factory to define a control and a corresponding binding; and
adding the defined control and binding to a form to generate the UI.

2. The method of claim 1 wherein the generated UI creates and views instances by enumerating the properties that belong to the type of object and by stacking the corresponding controls so that the user can interact with them.

3. The method of claim 2 wherein the user can interact with each control by viewing existing values and changing them.

4. The method of claim 2 wherein the values on the controls can be set on an instance corresponding to the type of object used to generate the UI.

5. The method of claim 1 further comprising mapping types to the UI controls that show and gather data of the mapped types.

6. The method of claim 1 wherein the predefined set of type mappings are data structures which comprise a dictionary where keys are type objects and the value of each key is an arbitrary object including a lookup function.

7. The method of claim 1 wherein when comparing the associated properties comprises selecting a control factory corresponding to a base type mapping when the associated properties do not correspond to any of the predefined set of type mappings.

8. The method of claim 1 further comprising using reflection to initialize the metadata in the defined controls, to obtain the associated properties, and to extract the final value of a control, and setting the extracted final value of a control into multiple instances of the corresponding type mapping whereby the UI is used to change values in multiple target instances.

9. In a computer system having an application using a user interface (UI) for an input/output device for the application, a method of generating the UI from an assembly of object classes of the application, each object class having metadata and associated properties, said method comprising:
building controls for assembled object classes by reading the metadata and associated properties of the object classes,
comparing the associated properties with a pre-defined set of type mappings to select a corresponding control factory from a plurality of factories, and
executing the selected factory wherein the executed factory defines a control and a corresponding binding added to a form to create the UI.

10. The method of claim 9 wherein the generated UI creates and views instances by enumerating the properties that belong to the type of object and by stacking the corresponding controls so that the user can interact with them.

11. The method of claim 10 wherein the user can interact with each control by viewing existing values and changing them.

12. The method of claim 10 wherein the values on the controls can be set on an instance corresponding to the type of object used to generate the UI.

13. The method of claim 9 further comprising mapping types to the UI controls that show and gather data of the mapped types.

14. The method of claim 9 wherein the predefined set of type mappings are data structures which comprise a dictionary where keys are type objects and the value of each key is an arbitrary object including a lookup function.

15. The method of claim 9 wherein when comparing the associated properties comprises selecting a control factory corresponding to a base type mapping when the associated properties do not correspond to any of the predefined set of type mappings.

16. The method of claim 9 further comprising using reflection to initialize the metadata in the defined controls, to obtain the associated properties, and to extract the final value of a control, and setting the extracted final value of a control into multiple instances of the corresponding type mapping whereby the UI is used to change values in multiple target instances.

17. A computer readable medium having instructions for providing a unified programming interface to generate a UI for the different input/output devices, such as graphical UI applications, command line applications, telephone applications, said instructions comprising:
Identifying a type of object class to illustrate as a target IU,
Obtaining an array of object classes which represent the metadata of the properties to be illustrated;
Creating a device corresponding to the target UI;
Using the device to create the corresponding controls and bindings;
Using the created bindings to populate the UI; and
iterating thru the bindings and using them to set values from the controls into the object class.

18. The computer readable medium of claim 17 wherein the generated UI creates and views instances by enumerating the properties that belong to the type of object and by stacking the corresponding controls so that the user can interact with them, wherein the user can interact with each control by viewing existing values and changing them and wherein the values on the controls can be set on an instance corresponding to the type of object used to generate the UI.

19. The computer readable medium of claim 17 further comprising mapping types to the UI controls that show and gather data of the mapped types, wherein the predefined set of type mappings are data structures which comprise a dictionary where keys are type objects and the value of each key is an arbitrary object including a lookup function and wherein when comparing the associated properties comprises selecting a control factory corresponding to a base type mapping when the associated properties do not correspond to any of the predefined set of type mappings.

20. The computer readable medium of claim 17 further comprising using reflection to initialize the metadata in the defined controls, to obtain the associated properties, and to extract the final value of a control, and setting the extracted final value of a control into multiple instances of the corresponding type mapping whereby the UI is used to change values in multiple target instances.
